(19) United States
(12) Patent Application Publication
(10) Pub. No.: US 2020/0376934 A1
(43) Pub. Date: Dec. 3, 2020

(54) VEHICLE AIR FILTRATION SYSTEM

(71) Applicant: GM GLOBAL TECHNOLOGY OPERATIONS LLC, Detroit, MI (US)

(72) Inventors: Nicholas Mazzocco, Clawson, MI (US); Derek Giordano, Lyon Township, MI (US)

(21) Appl. No.: 16/427,685

(22) Filed: May 31, 2019

(51) Int. Cl. B60H 3/06; B01D 46/00

(52) U.S. Cl. CPC B60H 3/0625; B01D 2279/40; B60H 3/0658; B01D 46/0023

(57) ABSTRACT

A vehicle air filtration system includes a housing having a first air filter having a first filtration level and positioned upstream of a second air filter having a second filtration level that is different than the first filtration level and a bypass door selectively operable to bypass air flow around the second air filter through a bypass passage.

### FIELD

The present disclosure relates to vehicle air filtration system.

### INTRODUCTION

This introduction generally presents the context of the disclosure. Work of the presently named inventors, to the extent it is described in this introduction, as well as aspects of the description that may not otherwise qualify as prior art at the time of filing, are neither expressly nor impliedly admitted as prior art against this disclosure.

Conventional vehicle air filtration systems are integrated into vehicle heating, ventilation, and air condition (HVAC) systems. These vehicle HVAC systems typically include an HVAC module which is positioned near or within the vehicle passenger cabin and the HVAC module houses a blower, a heater core, and an evaporator. The HVAC module includes an air inlet which provides access to a supply of air. These vehicles also typically include an air filter within the HVAC module which is positioned to filter the air before encountering the blower, heater core, and/or evaporator before exiting the HVAC module and entering the vehicle passenger cabin. The supply of air may be selectively provided either from outside of the vehicle (fresh air) or from the passenger cabin (recirculated air). In this manner, filtered air may always be provided to the passenger cabin.

It is desirable to improve the quality of the filtered air in the vehicle passenger cabin. In order to improve the quality of air, the filtering capability of the air filter may be increased. For example, an air filter may be selected which only permits the passage of increasingly smaller particle sizes. However, air filters which only permit the passage of very small particles have a high flow resistance which may limit the volume of air that can be provided to the vehicle passenger cabin. This can be a serious limitation because a high volume of air may be required to provide for window clearing in a reasonable amount of time. A high flow resistance air filter may prevent the ability to provide for adequate window clearing.

Additionally, air filters which only permit the passage of very small particles may clog much more quickly than air filters which permit the passage of larger particles. An air filter which clogs quickly undesirably requires frequent replacement and increases the cost of operation.

Vehicle manufacturers have attempted to provide a higher level of filtration to vehicle cabin air, however, these vehicle air filtration systems have required an air filter which is extremely large. These extremely large filters have resulted in air filters being placed in very unconventional locations within the vehicle, such as, for example a vehicle storage area external to a vehicle passenger cabin. These systems also require extensive air conduits to extend from these remote locations to provide air to the passenger cabin. This not only adversely affects the ability to provide a space efficient vehicle design, but also does not provide a high filtration level for air that is recirculated in the vehicle and significantly limits the ability to provide a high flow of filtered air to satisfy window clearing requirements. It is desirable to provide a high level of air filtration to vehicle cabin air which includes high level filtering of both a fresh air supply and recirculated air, in a compact space, which saves cost, reduces the energy required to operate the vehicle air filtration system, and does not clog too quickly.

### SUMMARY

In an exemplary aspect, a vehicle air filtration system for a vehicle includes a housing defining an air inlet and an air outlet connected by an air passage a first air filter positioned within the air passage having a first filtration level, a second air filter positioned downstream of the first air filter within the air passage and having a second filtration level that is different than the first filtration level, and a bypass door positioned in the housing selectively operable to connect the air passage a bypass passage further defined by the housing. The bypass passage has a bypass passage inlet at the bypass door. The bypass inlet is positioned in the air passage downstream of the first air filter and upstream of the second air filter. The bypass passage has a bypass passage outlet positioned in the air passage downstream of the second air filter.

In another exemplary aspect, the housing comprises an HVAC module.

In another exemplary aspect, the second air filter comprises a HEPA filter.

In another exemplary aspect, the second air filter filters out smaller particles than the first air filter.

In another exemplary aspect, the second air filter has a higher air flow resistance than the first air filter.

In another exemplary aspect, the system further includes a blower positioned in the housing, a heater core positioned in the housing, and an evaporator positioned in the housing.

In another exemplary aspect, the blower, heater core, and evaporator are positioned downstream of the first air filter and second air filter within the housing.

In another exemplary aspect, the air inlet of the housing is selectively connectable to an outside air source for receiving fresh air and a vehicle passenger cabin air source for receiving recirculating air.

Further areas of applicability of the present disclosure will become apparent from the detailed description provided below. It should be understood that the detailed description and specific examples are intended for purposes of illustration only and are not intended to limit the scope of the disclosure.

The above features and advantages, and other features and advantages, of the present invention are readily apparent from the detailed description, including the claims, and exemplary embodiments when taken in connection with the accompanying drawings.

### BRIEF DESCRIPTION OF THE DRAWINGS

The present disclosure will become more fully understood from the detailed description and the accompanying drawings, wherein:

FIG. 1 is a schematic of a vehicle incorporating an exemplary vehicle air filtration system in accordance with the present disclosure:

FIG. 2 is an elevation view of a cross-section of a conventional HVAC module with a vehicle air filtration system;

FIG. 3 is an elevation view of a cross-section of an HVAC module with an exemplary vehicle air filtration system in a first configuration in accordance with the present disclosure; and

FIG. 4 is another elevation view of the HVAC module of FIG. 3 in a second configuration.

### DETAILED DESCRIPTION

Reference will now be made in detail to several examples of the disclosure that are illustrated in accompanying drawings. Whenever possible, the same or similar reference numerals are used in the drawings and the description to refer to the same or like parts or steps. The drawings are in simplified form and are not to precise scale. For purposes of convenience and clarity only, directional terms such as top, bottom, left, right, up, over, above, below, beneath, rear, and front, may be used with respect to the drawings. These and similar directional terms are not to be construed to limit the scope of the disclosure in any manner.

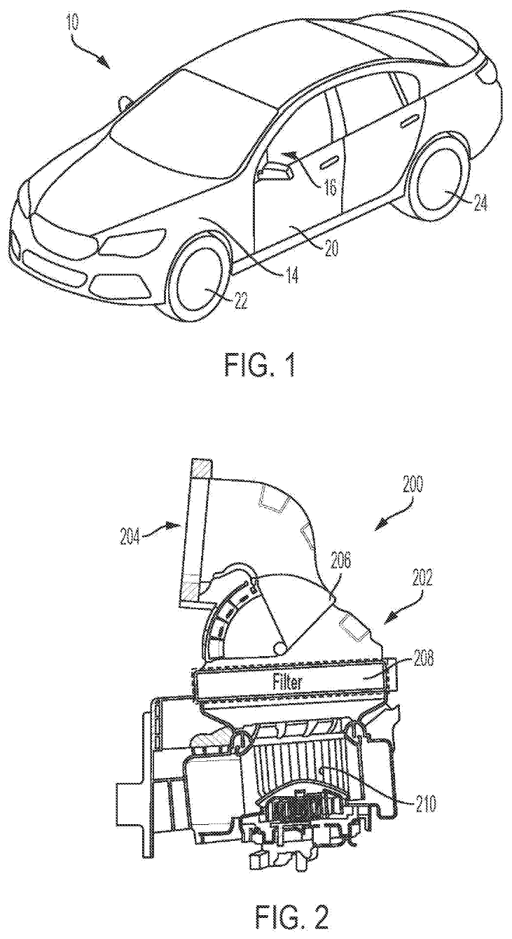

Referring now to the drawings, wherein like reference numbers correspond to like or similar components throughout the several figures, FIG. 1 is a schematic of a vehicle 10 incorporating an exemplary vehicle air filtration system in accordance with the present disclosure. The vehicle 10 includes a vehicle body 14 defining a passenger cabin 16. In addition, the vehicle 10 includes at least one door 200 movably coupled to the vehicle body 14. Aside from the door 20, the vehicle 10 includes front wheels 22 and rear wheels 24. The front and rear wheels 22, 24 are operatively coupled to the vehicle body 14.

FIG. 2 is an elevation view of a cross-section of a conventional HVAC module 200 with a vehicle air filtration system 202. The HVAC module 200 includes an air inlet 204, an air conduit 206, and an air filter 208 and a blower 210 positioned within the air conduit 206. The HVAC module 200 may be positioned in a vehicle passenger cabin and the air inlet 204 may selectively receive air either from within the vehicle passenger cabin (recirculated air) or from outside of the vehicle (fresh air). The HVAC module 200 provides a compact package which may be easily placed within a small area such as, for example, under an instrument panel (not shown) within the vehicle passenger cabin. The HVAC module 200 is configured such that air flowing through the HVAC module is always filtered by the air filter 208. Therefore, the filtering capacity of the air filter 208 is limited because it must be capable of flowing a sufficient flow of air to satisfy window clearing requirements and without clogging prematurely.

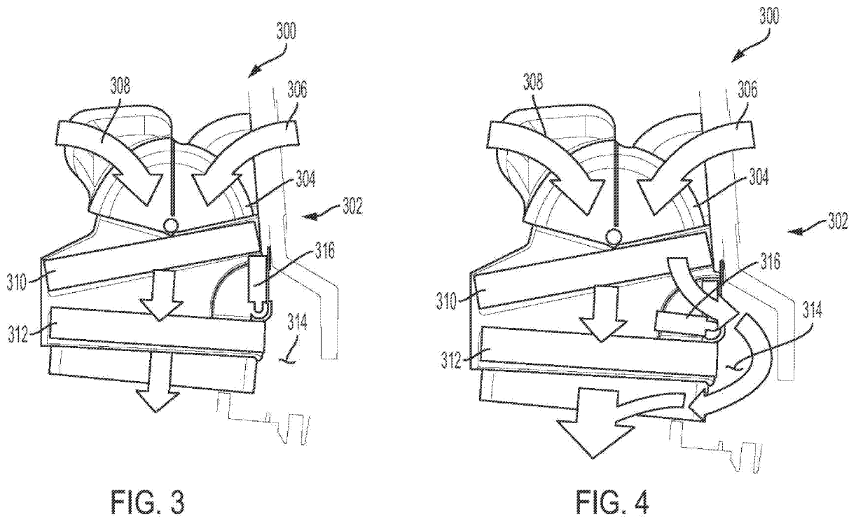

FIG. 3 is an elevation view of a cross-section of an HVAC module 300 with an exemplary vehicle air filtration system 302 in a first configuration in accordance with the present disclosure. The HVAC module 300 includes an air passage 304 which is selectively configurable to provide fresh air 306 and/or recirculating air 308. The vehicle air filtration system 302 includes a first air filter 310 and a second air filter 312 positioned within the air passage 304. The second air filter 312 provides a higher level of air filtration than the first air filter 310. The vehicle air filtration system 302 also includes a bypass passage 314 and a bypass door 316 which selectively enables a flow of air through the HVAC module to bypass the second air filter 312. FIG. 3 illustrates the HVAC module 300 with the bypass door 316 closed such that the flow of air through the module 300 does not bypass the second air filter 312.

In contrast, FIG. 4 illustrates the HVAC module 300 in a bypass configuration where the bypass door 216 is open and the air flowing through the module 300 flows through the bypass passage 314 and does not flow through the second air filter 312. In this manner, the vehicle air filtration system is able to provide a high flow of air when needed as in, for example, a window clearing operation by opening the bypass door 316 while also providing the capability of providing a higher level of filtration by closing the bypass door 316 such that the air flows through both the first air filter 310 and the second air filter 312.

As mentioned previously, the second air filter 312 may provide a higher level of filtration than the first air filter 310. For example, the second air filter 312 may provide for HEPA level of filtration while the first air filter 310 may provide a lower level of filtration. In general, the higher level of filtration provided by the second air filter 312 means that the second air filter 312 has a higher resistance to air flowing through the filter 312. In contrast, air may flow more easily through the first air filter 310, thereby enabling a higher flow of air when in the bypass mode of operation with the bypass door 316 open. The use of a first air filter 310 before the more restrictive second air filter 312 also has the benefit of extending the useful life of the second air filter 312. The larger particles which are captured by the first air filter 310 do not reach the second air filter 312. Therefore, in comparison to vehicle air filtration systems which do not have the inventive configuration, an air filter having a higher level of filtration is protected from clogging as early as previously has been experienced. The inventive vehicle air filtration provides all of these benefits while being packaged in a small space which may be conveniently positioned within the vehicle passenger cabin such as, for example, under a vehicle instrument panel.

This description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

what is claimed is:

1. A vehicle air filtration system for a vehicle, the system comprising:
a housing defining an air inlet and an air outlet connected by an air passage;
a first air filter positioned within the air passage having a first filtration level;
a second air filter positioned downstream of the first air filter within the air passage and having a second filtration level that is different than the first filtration level; and
a bypass door positioned in the housing selectively operable to connect the air passage a bypass passage further defined by the housing, the bypass passage having a bypass passage inlet at the bypass door, wherein the bypass inlet is positioned in the air passage downstream of the first air filter and upstream of the second air filter, and wherein the bypass passage has a bypass passage outlet positioned in the air passage downstream of the second air filter.

2. The system of claim 1, wherein the housing comprises an HVAC module housing.

2. The system of claim 1, wherein the second filtration level is higher than the first filtration level.

3. The system of claim 1, wherein the second air filter comprises a HEPA filter.

4. The system of claim 1, wherein the second air filter filters out smaller particles than the first air filter.

5. The system of claim 1, wherein the second air filter has a higher air flow resistance than the first air filter.

6. The system of claim 1, further comprising:
a blower positioned in the housing;
a heater core positioned in the housing; and
an evaporator positioned in the housing.

7. The system of claim 7, wherein the blower, heater core, and evaporator are positioned downstream of the first air filter and second air filter within the housing.

8. The system of claim 1, wherein the air inlet of the housing is selectively connectable to an outside air source for receiving fresh air and a vehicle passenger cabin air source for receiving recirculating air.

9. A vehicle having a vehicle air filtration system, the vehicle comprising:
a vehicle body defining a vehicle passenger cabin;
a housing defining an air inlet and an air outlet connected by an air passage;
a first air filter positioned within the air passage having a first filtration level;
a second air filter positioned downstream of the first air filter within the air passage and having a second filtration level that is different than the first filtration level; and
a bypass door positioned in the housing selectively operable to connect the air passage a bypass passage further defined by the housing, the bypass passage having a bypass passage inlet at the bypass door, wherein the bypass inlet is positioned in the air passage downstream of the first air filter and upstream of the second air filter, and wherein the bypass passage has a bypass passage outlet positioned in the air passage downstream of the second air filter.

10. The vehicle of claim 10, wherein the housing comprises an HVAC module housing.

10. The vehicle of claim 10, wherein the second filtration level is higher than the first filtration level.

11. The vehicle of claim 10, wherein the second air filter comprises a HEPA filter.

12. The vehicle of claim 10, wherein the second air filter filters out smaller particles than the first air filter.

13. The vehicle of claim 10, wherein the second air filter has a higher air flow resistance than the first air filter.

14. The vehicle of claim 10, further comprising:
a blower positioned in the housing;
a heater core positioned in the housing; and
an evaporator positioned in the housing.

15. The vehicle of claim 16, wherein the blower, heater core, and evaporator are positioned downstream of the first air filter and second air filter within the housing.

16. The vehicle of claim 10, wherein the air inlet of the housing is selectively connectable to an outside air source for receiving fresh air and a vehicle passenger cabin air source for receiving recirculating air.
